(19) United States
(12) Patent Application Publication
(10) Pub. No.: US 2025/0114772 A1
(43) Pub. Date: Apr. 10, 2025

(54) Composition of Aluminium Oxide and Cerium Oxide

(71) Applicant: Rhodia Operations, Lyon (FR)

(72) Inventors: Julien Hernandez, Antony (FR); Oguzhan Yaglidere, Cincinnati, OH (US); Virginie Harle, Senlis (FR); Simon Ifrah, La Jarrie (FR)

(21) Appl. No.: 18/293,416

(22) PCT Filed: Jul. 25, 2022
(86) PCT No.: PCT/EP2022/070837

§ 371 Date: Jan. 30, 2024

(30) Foreign Application Priority Data
Jul. 30, 2021 (EP) 21315134.3

(51) Int. Cl. B01J 23/63; B01J 35/63; B01J 35/77; B01J 37/04; B01J 37/08; C01F 17/32

(52) U.S. Cl. CPC B01J 23/63; B01J 35/633; B01J 35/635; B01J 35/638; B01J 35/77; B01J 37/04; B01J 37/08; C01F 17/32; B01J 2523/31; B01J 2523/3706; B01J 2523/3712; B01J 2523/822; B01J 2523/824; B01J 2523/828; C01P 2002/60; C01P 2006/10; C01P 2006/12; C01P 2006/14

(57) ABSTRACT

The invention relates to a composition which is a composition C1 which is based on Al and Ce in the form of oxides; or a composition C2 which is based on Al, Ce and La in the form of oxides with the following proportions of CeO₂ is between 5.0 wt % and 35.0 wt %; La₂O₃ (for composition C2 only) is between 0.1 wt % and 6.0 wt %; the remainder being Al₂O₃; and exhibiting a specific porosity profile and exhibiting the following properties of a mean size of the crystallites after calcination in air at 1100° C. for 5 hours (denoted D_{1100° C.-5h}) which is lower than 45.0 nm; a mean size of the crystallites after calcination in air at 900° C. for 2 hours (denoted D_{900° C.-2h}) which is lower than 25.0 nm; and an increase ΔD of the mean size of the crystallites lower than 30.0 nm, ΔD being calculated with the following formula: ΔD=D_{1100° C.-5h}−D_{900° C.-2h}; the mean size of the crystallites being obtained by XRD from the diffraction peak of the cubic phase corresponding to cerium oxide, generally present at 2θ between 28.0° and 30.0°.

### CROSS-REFERENCE TO RELATED APPLICATIONS

This application is the United States national phase of International Application No. PCT/EP2022/070837 filed Jul. 25, 2022, and claims priority to European Patent Application No. 21315134.3 filed Jul. 30, 2021, the disclosures of which are hereby incorporated by reference in their entireties.

### BACKGROUND OF THE INVENTION

### Field of the Invention

The present invention relates to a composition of aluminium oxide, cerium oxide and optionally lanthanum oxide with a particular porosity profile that maintains a high specific surface area and a low crystallite size even after calcination at high temperatures. The invention also relates to a catalytic composition comprising said composition and to the use of the composition.

### Description of Related Art

Catalysts for purifying vehicle exhaust gas are now almost mandatory in order to meet pollutants regulations that are in force in most of the regions worldwide (e.g. Europe, USA, Japan, China, Korea, India, . . . ). The function of the catalyst is to remove pollutants like CO, unburnt particulate matter (e.g. soot), unburnt hydrocarbons (HC), nitrogen oxides NO and NO₂ (referenced as NOx) that are noxious for health and for the environment.

Regulations are now becoming more and more challenging and are still expected to be stricter in the near future: see Euro 7 in Europe, SULEV 20 in the USA or China 6b in China. Emissions in real conditions are now also controlled like in Europe with RDE limits (Real Driving Emission) which add another challenge as the catalysts have to be efficient in a large variety of driving conditions. As a consequence, there is a requirement for having more and more efficient catalysts.

### TWC Catalysts

For gasoline vehicles, the control of the emissions is achieved using the so-called ‘three-way’ catalyst (TWC) which can simultaneously decrease the amounts of hydrocarbons, CO and NOx. Natural gas vehicles may also generally rely on TWC catalysts when the engine is running in stoichiometric mode. Yet, the same challenge as for gasoline engines is expected. In addition, the fuel to air ratio is expected to be broader which would require larger Oxygen Storage Capacity (OSC).

### GPF

Gasoline vehicles are also equipped in several regions with gasoline particulate filters (GPF), the function of which is to reduce the release of particulate matter emitted in particular, but not only, for gasoline direct injection engine technologies. The GPF is based on a TWC catalyst coated on the filter and having an increased OSC to promote the additional need of oxygen to burn the particulate matter. There is therefore a general need for catalysts exhibiting an improved OSC.

### DOC and DPF

For diesel engines, several catalysts can be used like the Diesel Oxidation Catalyst (DOC) to control the oxidation functions of CO, HC but also to some extent particulate matter and NOx. Diesel engines are now also in general fitted with Diesel Particulate Filters (DPF), the function of which is to filter and burn the particulate matter. So the oxidation function is key for DOC and DPF and this is important to keep oxidation function after thermal stress due to soot oxidation during DPF regeneration. NOx emissions for diesel engines are either managed by Selective Catalytic Reduction (SCR) catalyst where the NOx reduction is obtained through the reaction between NOx and NH₃ or by NOx trapping or adsorption on Lean NOx Trap (LNT) or Partial NOx Absorber (PNA). In both cases, oxidation function is needed to efficiently remove the NOx.

### Technical Problem

The above-disclosed catalysts also require in all cases (except for SCR) the presence of at least one noble metal (e.g. Pt, Pd and Rh) also known as platinum group metal (or PGM). Rh and Pd are generally more expensive than Pt, so that Pt tends to be now more commonly used. Due to the price of the PGMs, there is a general requirement to minimize their content in the catalysts. The PGMs, notably Pd and Pt, are dispersed on the surface of alumina and known to be stabilized by cerium oxide.

All the above-disclosed catalysts comprise alumina which is either used to disperse the PGM(s) (TWC, GPF, DOC, DPF, LNT, PNA) or mixed with a SCR catalyst (e.g. in general zeolite based or vanadium oxide associated with titanium oxide). All of them also comprise a ceria-based material which provides the Oxygen Storage Capacity (OSC) or assists the oxidation. Thermal stability is required for both alumina and the ceria-based material.

There is therefore a need for a thermally resistant alumina-based support which can be used for the preparation of a catalyst containing at least one PGM and which exhibits an OSC and which can stabilize the PGM(s) present in the catalyst. In the context of the present application, the term ‘thermally resistant’ is used to characterize a support which is able to maintain a high specific surface area and/or a small particle size after a heat treatment at high temperature. A simple and common way of characterizing the thermal stability of the support consists in measuring its specific surface area after a calcination in air at high temperature. Another way is to measure the particle size of the particles by X-ray diffraction (XRD) after the same treatment. The expression ‘high temperature’depends on the nature of the catalyst used: in general the temperature of calcination is around 900° C. maximum for a diesel catalyst (like a DOC, DPF, LNT or SCR) and around 1100° C., even sometimes 1200° C., for a gasoline or natural gas catalyst (like a TWC or GPF).

In addition, inorganic materials with a high pore volume, in particular with high pore volume for the pores having a size below 1000 nm, are useful to enable a good diffusion of the gases which promotes a high conversion of pollutants. This is very relevant in Real Driving Conditions or when the vehicle is running at high speed with high gas flow. However, too large pore a volume will tend to decrease the density of the inorganic material and introduce some difficulty during the preparation of the catalyst. The preparation of a catalyst generally involves coating of a suspension of a catalytic composition composed of inorganic materials onto a substrate or a monolith. It is of course more convenient for the preparation to use a highly concentrated suspension exhibiting a low viscosity. There is therefore also a need for a thermally resistant support which can be easily handled and used for the preparation of a highly concentrated and with low viscosity suspension. As a consequence there is a compromise for porosity to balance catalyst efficiency and catalyst preparation.

The composition of the invention aims at solving these technical problems.

### TECHNICAL BACKGROUND

WO 12067654 discloses a porous inorganic composite oxide, comprising oxides of aluminum and cerium, or oxides of aluminum and zirconium, or oxides of aluminum, cerium, and zirconium, and, optionally, one or more oxides of dopants selected from transition metals, rare earths, and mixtures thereof. There is no disclosure of the composition as in claim 1.

### SUMMARY OF THE INVENTION

The invention relates to a composition as defined herein. This composition is according to two main embodiments C1 or C2:
a composition C1 which is based on Al and Ce in the form of oxides;
a composition C2 which is based on Al, Ce and La in the form of oxides.
   with the following proportions:
the proportion of CeO₂ is between 5.0 wt % and 35.0 wt %;
the proportion of La₂O₃ (for composition C2 only) is between 0.1 wt % and 6.0 wt %;
the remainder as Al₂O₃;
   and which exhibits the following porosity profile:
a pore volume in the range of pores with a size of between 5 nm and 100 nm (denoted PV_{5-100 nm}) which is:
   for a proportion of CeO₂ between 5.0 wt % and 15.0 wt % lower than 0.90 mL/g, more particularly lower than 0.85 mL/g, even more particularly lower than 0.82 mL/g;
   for a proportion of CeO₂ between 15.0 wt % (this value being excluded) and 22.0 wt % lower than 0.85 mL/g, more particularly lower than 0.80 mL/g, even more particularly lower than 0.75 mL/g;
   for a proportion of CeO₂ between 22.0 wt % (this value being excluded) and 35.0 wt % lower than 0.70 mL/g, more particularly lower than 0.65 mL/g;
a pore volume in the range of pores with a size of between 5 nm and 1000 nm (denoted PV_{5-1000 nm}) which is lower than 1.30 mL/g, more particularly lower than 1.20 mL/g, even more particularly lower than 1.10 mL/g or lower than 1.00 mL/g;
a pore volume in the range of pores with a size of between 100 nm and 1000 nm (denoted PV_{100-1000 nm}) which is strictly higher than 0.10 mL/g;
   these pore volumes being determined by means of the mercury porosimetry technique;
   and the following properties:
a mean size of the crystallites after calcination in air at 1100° C. for 5 hours (denoted D_{1100° C.-5h}) which is lower than 45.0 nm, preferably lower than 40.0 nm;
a mean size of the crystallites after calcination in air at 900° C. for 2 hours (denoted D_{900° C.-2h}) which is lower than 25.0 nm, preferably lower than 20.0 nm, even more preferably lower than 16.0 nm; and
an increase ΔD of the mean size of the crystallites lower than 30.0 nm, preferably lower than 25.0 nm, ΔD being calculated with the following formula: ΔD=D_{1100° C.-5h}−D_{900° C.-2h};
the mean size of the crystallites being obtained by XRD from the diffraction peak of the cubic phase corresponding to cerium oxide, generally present at 2θ between 28.0° and 30.0°.

The invention also relates to a catalytic composition as defined herein, and also to the use of the composition as defined herein and to the use of the catalytic composition as defined herein. The invention relates to a process for preparing the composition as defined herein.

All these objects are now defined in greater details.

### DESCRIPTION OF THE INVENTION

In the present patent application, it is specified, for the continuation of the description, that, unless otherwise indicated, in the ranges of values which are given, the values at the limits are included. It is also specified that the calcinations are performed in air. On this regard, “strictly higher than 0.10 mL/g” refers to the following mathematical sign “>0.10 mL/g” which means that the value of 0.10 mL/g is excluded.

“wt %” denotes a % by weight.

In the context of the invention, the term ‘particle’ means an agglomerate formed from primary particles. The particle size is determined from a particle size distribution by volume obtained by means of a laser particle size analyzer. The particle size distribution is characterized by means of the parameters D10, D50 and D90. These parameters have the usual meaning in the field of measurements by laser diffraction. Dx thus denotes the value which is determined with regard to the particle size distribution by volume for which x % of the particles have a size less than or equal to this value Dx. D50 thus corresponds to the median value of the distribution. D90 corresponds to the size for which 90% of the particles have a size which is less than D90. D10 corresponds to the size for which 10% of the particles have a size which is less than D10. The measurement is generally performed on a dispersion of the particles in water.

In the context of the invention, a rare earth element means an element of the group comprising yttrium and the elements of the Periodic Table with an atomic number between 57 and 71 inclusive.

The porosity data in the present application are obtained via the mercury porosimetry technique or the nitrogen porosimetry technique (for TPV*). Both techniques make it possible to define the pore volume (V) as a function of the pore diameter (D).

For the mercury porosimetry technique, use may be made of a Micromeritics Autopore 9520 machine equipped with a powder penetrometer in accordance with the instructions recommended by the manufacturer. The procedure of ASTM D 4284-07 may be followed. By means of these data, it is possible to determine the pore volume for the pores having a size between 5 nm and 100 nm (denoted PV_{5-100 nm}), the pore volume for the pores having a size between 5 nm and 1000 nm (denoted PV_{5-1000 nm}), the pore volume for the pores having a size between 100 and 1000 nm (denoted PV_{100-1000 nm}) and the total pore volume (denoted TPV).

For the nitrogen porosimetry technique, use may be made of a Tristar 3020 from Micromeritics. By means of these data, it is possible to determine the total pore volume for the composition after calcination in air at 900° C. for 2 hours (denoted TPV*).

The term “specific surface area” means the BET specific surface area determined by nitrogen adsorption determined by means of the Brunauer-Emmett-Teller method. This method was described in the journal “The Journal of the American Chemical Society, 60, 309 (1938)”. The recommendations of the standard ASTM D3663-03 may be followed. Unless otherwise indicated, the calcinations for a given temperature and a given duration correspond to calcinations in air at a steady temperature stage over the duration indicated.

Furthermore, it is specified that the concentrations of the solutions or the proportions in the composition of the elements Al, Ce and La (if any) are given as weight percentages of oxide equivalents. The following oxides are thus retained for the calculation of these concentrations or proportions: Al₂O₃ for Al, CeO₂ for Ce and La₂O₃ for La. For example, an aqueous aluminum sulfate solution with an aluminum concentration of 2.0 wt % corresponds to a solution containing 2.0% by weight of Al₂O₃ equivalent. Similarly, a composition with 92.0 wt % of Al and 8.0 wt % of Ce corresponds to 92.0 wt % of Al₂O₃ and 8.0 wt % of CeO₂.

The composition is based on Al and Ce in the form of oxides (composition C1) or Al, Ce and La in the form of oxides (composition C2). According to an embodiment, composition C1 consists of oxides of Ce and Al. According to another embodiment, composition C2 consists of oxides of Ce, Al and La.

First of all, the composition is defined by the proportions of its constituents. Their proportions are given by weight relative to the total weight of the composition. Thus, for compositions C1 and C2, the proportion of CeO₂ is between 5.0 wt % and 35.0 wt %, or between 5.0 wt % and 30.0 wt % or even between 6.0 wt % and 25.0 wt %. This proportion may also be between 10.0 wt % and 25.0 wt % or even between 15.0 wt % and 25.0 wt %. The proportion may also be between:
6.0 wt % and 10.0 wt %; or
10.0 wt % and 14.0 wt %; or
18.0 wt % and 22.0 wt %.

The proportion of CeO₂ may be lower than 20.0 wt %.

For composition C2, the proportion of La is between 0.1 wt % and 6.0 wt % or even between 0.5 wt % and 6.0 wt % or even between 1.0 wt % and 5.0 wt %, this proportion being expressed as weight of La₂O₃ relative to the total weight of the composition.

The proportion of Al₂O₃ corresponds to the remainder to 100%. Al₂O₃ is the major constituent of the composition. For composition C1, the proportion of Al₂O₃ is between 65.0 wt % and 95.0 wt %. For composition C2, the proportion of Al₂O₃ is between 59.0 wt % and 94.9 wt %.

For composition C1, the following proportions of CeO₂ and Al₂O₃ are between:
6.0 wt % and 10.0 wt % for CeO₂ and 90.0 wt % and 94.0 wt % for Al₂O₃; or
10.0 wt % and 14.0 wt % for CeO₂ and 86.0 wt % and 90.0 wt % for Al₂O₃; or
18.0 wt % and 22.0 wt % for CeO₂ and 78.0 wt % and 82.0 wt % for Al₂O₃.

Then, the composition is also defined by a good compromise between physico-chemical properties, in particular the porosity and the crystallite size of ceria. The pore volumes (PV_{5-100 nm} and PV_{5-1000 nm}) are limited to facilitate the preparation of a catalyst or of a washcoat while the crystallite size of ceria remains low even after calcination at high temperatures. Moreover, the pore volumes (PV_{5-100 nm} and PV_{5-1000 nm}) may be higher than a minimum value to facilitate the dispersion of ceria and to ensure thermal stability of the composition even after calcination at high temperatures.

Thus, the composition is characterized by the following porosity profile:
a pore volume in the range of pores with a size of between 5 nm and 100 nm (denoted PV_{5-100 nm}) which is:
   for a proportion of CeO₂ between 5.0 wt % and 15.0 wt % lower than 0.90 mL/g, more particularly lower than 0.85 mL/g, even more particularly lower than 0.82 mL/g;
   for a proportion of CeO₂ between 15.0 wt % (this value being excluded) and 22.0 wt % lower than 0.85 mL/g, more particularly lower than 0.80 mL/g, even more particularly lower than 0.75 mL/g;
   for a proportion of CeO₂ between 22.0 wt % (this value being excluded) and 35.0 wt % lower than 0.70 mL/g, more particularly lower than 0.65 mL/g;
a pore volume in the range of pores with a size of between 5 nm and 1000 nm (denoted PV_{5-1000 nm}) which is lower than 1.30 mL/g, more particularly lower than 1.20 mL/g, even more particularly lower than 1.10 mL/g or lower than 1.00 mL/g;
a pore volume in the range of pores with a size of between 100 nm and 1000 nm (denoted PV_{100-1000 nm}) which is strictly higher than 0.10 mL/g.

PV_{5-100 nm} may also be the following:
for a proportion of CeO₂ between 5.0 wt % and 15.0 wt % higher than 0.40 mL/g, more particularly higher than 0.45 mL/g;
for a proportion of CeO₂ between 15.0 wt % (this value being excluded) and 22.0 wt % higher than 0.35 mL/g, more particularly higher than 0.40 mL/g;
for a proportion of CeO₂ between 22.0 wt % (this value being excluded) and 35.0 wt % higher than 0.30 mL/g, more particularly higher than 0.35 mL/g.

PV_{5-1000 nm} may also be higher than 0.70 mL/g, more particularly higher than 0.75 mL/g.

PV_{100-1000 nm} is strictly higher than 0.10 mL/g (>0.10 mL/g).

The invention relates also to a composition exhibiting the following porosity profile:
a pore volume in the range of pores with a size of between 5 nm and 100 nm (denoted PV_{5-100 nm}) which is:
   for a proportion of CeO₂ between 5.0 wt % and 15.0 wt % between 0.40 and 0.90 mL/g;
   for a proportion of CeO₂ between 15.0 wt % (this value being excluded) and 22.0 wt % between 0.35 and 0.85 mL/g;
   for a proportion of CeO₂ between 22.0 wt % (this value being excluded) and 35.0 wt % between 0.30 and 0.70 mL/g;
a pore volume in the range of pores with a size of between 5 nm and 1000 nm (denoted PV_{5-1000 nm}) which is between 0.70 and 1.30 mL/g;
a pore volume in the range of pores with a size of between 100 nm and 1000 nm (denoted PV_{100-1000 nm}) which is strictly higher than 0.10 mL/g.

Moreover, the composition may exhibit high specific surface areas. It may have a BET specific surface area of between 80 and 300 m²/g, more particularly between 90 and 200 m²/g. This specific surface area may be greater than or equal to 100 m²/g. This specific surface may also be between 100 and 200 m²/g.

The composition moreover has high thermal stability. It may have a BET specific surface area after calcination in air at 1100° C. for 5 hours which is higher than 40 m²/g, preferably higher than 45 m²/g. This specific surface area may be between 40 m²/g and 110 m²/g, preferably between 45 m²/g and 110 m²/g. This specific surface area may also be strictly lower than 82.35×(Al₂O₃)+11.157 m²/g wherein (Al₂O₃) corresponds to the proportion of Al₂O₃ in wt % in the composition. As an example, for a proportion of Al₂O₃ of 80.0 wt %, the calculation leads to a value of: 82.35×80.0%+11.157=77.037 m²/g.

The composition may also have a BET specific surface area after calcination in air at 1200° C. for 5 hours which is between 25 and 60 m²/g.

The composition generally has a total pore volume (TPV) which is generally greater than 0.70 mL/g. This total pore volume may advantageously be at least 0.80 mL/g, or even at least 0.90 mL/g. This total pore volume is generally not more than 2.50 mL/g, or even not more than 2.00 mL/g.

The composition may also exhibit a total pore volume measured by N₂ porosimetry after calcination in air at 900° C. for 2 hours (denoted TPV*) which is strictly lower than 0.97×(Al₂O₃)+0.0647 mL/g wherein (Al₂O₃) corresponds to the proportion of Al₂O₃ in wt % in the composition. As an example, for a proportion of Al₂O₃ of 80.0 wt %, the calculation leads to a value of: 0.97×80.0%+0.0647=0.8407 ml/g.

The composition may have a bulk density (ABD) between 0.20 g/cm³ and 0.50 g/cm³, more particularly between 0.25 g/cm³ and 0.40 g/cm³. This bulk density of the powder corresponds to the weight of a certain amount of powder relative to the volume occupied by this powder:

ABD in g/mL=(mass of the powder (g))/(volume of the powder (mL))

This bulk density may be determined by the method described below. Firstly, the volume of a measuring cylinder of about 25 mL with no spout is determined precisely. To do this, the empty measuring cylinder is weighed (tare T). Distilled water is then poured into the measuring cylinder up to the rim but without exceeding the rim (no meniscus). The measuring cylinder filled with distilled water is weighed (M). The mass of water contained in the measuring cylinder is thus:

$$E = M - T$$

The calibrated volume of the measuring cylinder is equal to V_{measuring cylinder}=E/(density of water at the measurement temperature). The density of the water is, for example, equal to 0.99983 g/mL for a measurement temperature of 20° C.

The composition in the form of powder is carefully poured into the empty and dry measuring cylinder using a funnel until the rim of the cylinder is reached. The excess powder is levelled off using a spatula. The powder must not be compacted or tamped down during the filling. The measuring cylinder containing the powder is then weighed.

$$bulk density ( g / mL ) = ( mass of the measuring cylinder containig the alumina powder - Tare T ( g ) ) / ( {V}_{measuring cylinder} ( mL ) )$$

The composition may have a D50 of between 2.0 μm and 80.0 μm. It may have a D90 of less than or equal to 150.0 μm, more particularly less than or equal to 100.0 μm. It may have a D10 of greater than or equal to 1.0 μm.

It will also be noted that the composition is crystalline. This may be demonstrated by means of X-ray diffraction. The composition comprises a crystalline phase based on alumina. Such phase may be a delta phase, a theta phase, a gamma phase or a mixture of at least two of these phases.

Composition C2 preferably does not comprise any XRD diffraction pattern of a phase containing lanthanum and aluminium, in particular any of the following phases LaAlO₃ or LaAl₁₁O₁₈. These last two phases may be identified by the following respective references of the International Centre for Diffraction Data: ICDD 01-070-4111 and ICDD 00-033-0699.

The composition also comprises a crystalline phase based on cerium oxide. This phase may correspond to pure CeO₂ or to CeO₂ containing lanthanum. This phase exhibits a diffraction line 2θ between 28.0° and 30.0°.

From the diffraction peak of the cubic phase corresponding to cerium oxide, which is present at 2θ between 28.0° and 30.0°, it is possible to determine the mean size of the crystallites. The composition exhibits indeed:
a mean size of the crystallites after calcination in air at 1100° C. for 5 hours (denoted D_{1100° C.-5h}) which is lower than 45.0 nm, preferably lower than 40.0 nm;
a mean size of the crystallites after calcination in air at 900° C. for 2 hours (denoted D_{900° C.-2h}) which is lower than 25.0 nm, preferably lower than 20.0 nm, even more preferably lower than 16.0 nm; and
an increase ΔD of the mean size of the crystallites lower than 30.0 nm, preferably lower than 25.0 nm, ΔD being calculated with the following formula: ΔD=D_{1100° C.-5h}−D_{900° C.-2h};
the mean size of the crystallites being obtained by XRD from the diffraction peak of the cubic phase corresponding to cerium oxide, generally present at 2θ between 28.0° and 30.0°.

The mean size D_{1100° C.-5h} is generally at least 8.0 nm. Likewise, the mean size D_{900° C.-2h} is generally at least 5.0 nm.

The mean size of the crystallites D is measured by X-ray diffraction. It corresponds to the size of the coherent domain calculated from the width of the diffraction line 2θ between 28.0° and 30.0° and using the Scherrer equation. According to the Scherrer equation, D is given by formula (I):

$$D = \frac{k λ}{B cos θ} \qquad ( I )$$

D: mean crystallite size;
k: shape factor equal to 0.9;
λ (lambda): wavelength of the incident beam (for a CuKα1 source, λ=1.5406 Angstrom);
B: line broadening measured at half the maximum intensity (radian);
θ: Bragg angle (radian)

One usually takes into account the broadening due to the instrument to determine B. In formula (II), the broadening due to the instrument is Bᵢₙₛₜᵣ and

$$D = \frac{k λ}{( {B}_{obs} - {B}_{instr} ) cos θ} \qquad ( II )$$

D: mean crystallite size;
k: shape factor equal to 0.9;
λ (lambda): wavelength of the incident beam (for a CuKα1 source, λ=1.5406 Angstrom);
B_{obs}: full width at half maximum of the diffraction peak (radian);
Bᵢₙₛₜᵣ: instrumental line broadening (radian);
θ: Bragg angle (radian).

Bᵢₙₛₜᵣ depends on the instrument used and on the 20 (theta) angle.

D50 and D90 are determined by means of a laser particle size analyzer from a particle size distribution by volume, the measurement being performed on a dispersion of the particles in water.

D10 is usually at least 0.5 μm.

The composition may also comprise some residual components. The composition may comprise residual sodium. The content of residual sodium may be less than or equal to 0.50 wt %, or even less than or equal to 0.15 wt %. The sodium content may be greater than or equal to 50 ppm. This content may be between 50 and 900 ppm, or even between 100 and 800 ppm. This content is expressed as weight of Na₂O relative to the total weight of the composition. Thus, for a composition having a residual sodium content of 0.15 wt %, it is considered that there is, per 100 g of the composition, 0.15 g of Na₂O. The method for determining the sodium content within this concentration range is known to those skilled in the art. For example, the composition can be digested in acidic conditions, the digestion being optionally assisted by microwaves and once the composition is fully dissolved, the acidic solution is titrated by inductively coupled plasma spectroscopy technique.

The composition may comprise residual sulfate. The content of residual sulfate may be less than or equal to 1.00 wt %, or even less than or equal to 0.50 wt %, or else even less than or equal to 0.25 wt %. The sulfate content may be greater than or equal to 50 ppm. This content may be between 100 and 2500 ppm, or even between 400 and 1000 ppm. This content is expressed as weight of sulfate relative to the total weight of the composition. Thus, for a composition having a residual sulfate content of 0.50 wt %, it is considered that there is, per 100 g of the composition, 0.50 g of SO₄. The method for determining the sulfate content within this concentration range is known to those skilled For instance, the same method as for the sodium titration can be applied.

The composition may contain impurities other than sodium and sulfate, for example impurities based on silicium, titanium or iron. The proportion of each impurity is generally less than 0.10 wt %, or even less than 0.05 wt %.

### Use of the Composition

The composition of the invention may be used in the field of catalysis and in particular in the preparation of a catalyst used to purify vehicle exhaust gas. The composition according to the invention may be used in the preparation of a catalytic converter, the role of which is to treat motor vehicle exhaust gases. The catalytic converter comprises at least one catalytically active coating layer prepared from the composition and deposited on a support. The role of the catalytic converter is to convert, by chemical reactions, certain pollutants of the exhaust gas, in particular carbon monoxide, unburnt hydrocarbons and nitrogen oxides, into products which are less harmful to the environment.

The composition of the invention may also be used for the preparation of a catalytic composition. A catalytic composition generally comprises:
(i) the composition of the invention; and
(ii) optionally at least one inorganic material other than the composition of the invention; and/or
(iii) optionally at least one platinum group metal (PGM).

According to an embodiment, the catalytic composition:
(i) the composition of the invention; and
(ii) at least one inorganic material other than the composition of the invention; and
(iii) optionally at least one platinum group metal (PGM).

According to another embodiment, the catalytic composition:
(i) the composition of the invention; and
(ii) at least one inorganic material other than the composition of the invention; and
(iii) at least one platinum group metal (PGM).

The inorganic material other than the composition of the invention is selected in the group consisting of zeolites; alumina-based materials; ceria-based materials; zirconia-based materials; mixed oxides comprising oxides of cerium and zirconium; mixed oxides comprising oxides of aluminium, cerium and zirconium; and combinations thereof.

The inorganic material may be a zeolite. The zeolite may be selected in the group consisting of AEI, AFT, AFV, AFX, AVL, CHA, DDR, EAB, EEI, ERI, IFY, IRN, KFI, LEV, LTA, LTN, MER, MWF, NPT, PAU, RHO, RTE, RTH, SAS, SAT, SAV, SFW, TSC, UFI and combinations thereof. The zeolite may be ion-exchanged with at least one catalytic metal, such as Cu, Fe, Ce and combinations thereof.

The inorganic material may be a ceria-based material. The ceria-based material may be selected in the group consisting of cerium oxide; mixed oxides of cerium and at least one rare earth element other than cerium and composite oxides of cerium and at least one alkaline earth element. The proportion of the rare earth element or of the alkaline earth element is usually between 1.0 wt % and 30.0 wt %, this proportion being expressed as oxides relative to the ceria-based material as a whole. Examples of ceria-based materials may be found in the following references: EP 1435338 B1, U.S. Pat. No. 8,435,919, EP 3218307 B1, EP 1435338.

The inorganic material may be an alumina-based material. The alumina-based material may be selected in the group consisting of alumina; alumina stabilized by at least one oxide of an element selected in the group consisting of silicon, zirconium, rare earth metals, alkaline earth metals; aluminium hydrate; and combinations thereof. The alumina-based material may more particularly be an alumina or an alumina stabilized by lanthanum oxide. The proportion of the stabilizing element is usually between 1.0 wt % and 10.0 wt %, this proportion being expressed as oxides relative to the alumina-based material as a whole. Examples of alumina-based materials may be found in the following references: US 2017/0129781, U.S. Pat. No. 4,301,037.

The inorganic material may be a zirconia-based material. The zirconia-based material may be selected in the group consisting of zirconia and zirconia stabilized by at least one oxide of an element selected in the group consisting of yttrium, lanthanum, praseodymium, cerium and combinations thereof. Examples of zirconia-based materials may be found in the following references: EP 1735242 B1, EP 1729883 B1 and EP 2646370 B1.

The inorganic material may be a mixed oxide comprising oxides of cerium and zirconium. The mixed oxide comprising oxides of cerium and zirconium may be selected in the group of mixed oxides of cerium and zirconium and mixed oxides of cerium, zirconium and at least one rare earth element other than cerium. Examples of mixed oxides comprising oxides of cerium and zirconium may be found in the following references: EP 1527018 B1, EP 3009403 B1, EP 0863846 B1, EP 2454196 B1, EP 1603667 B1, WO 2016037059.

The inorganic material may be mixed oxide comprising oxides of aluminium, cerium and zirconium. The mixed oxide comprising oxides of aluminium, cerium and zirconium may be selected in the group of mixed oxides of aluminium, cerium and zirconium and mixed oxides of aluminium, cerium, zirconium and at least one rare earth element other than cerium. Examples of such mixed oxides may be found in the following references: WO 2018/115436, US 2013/0336864, US 2013/0017947.

The platinum group metal (PGM) is an element selected in the group of group VIII of the periodic table. The platinum group metal may more particularly be and is usually selected in the group consisting of Pt, Pd, Rh and combinations thereof.

A catalytic composition is prepared by the usual techniques in the field known to the skilled person. For example, a process of preparation of said catalytic composition comprises the following steps: (a) preparing a suspension in an aqueous medium containing the composition of the invention and the inorganic material other than the composition of the invention, (b) wet-milling of the suspension of step (a), (c) optionally bringing into contact the suspension with an aqueous solution of at least one PGM, (d) coating the obtained suspension onto a support e.g. a monolith or a filter, (e) drying and/or calcining in air. As an alternative, the process does not comprise step (c) and the PGM is introduced onto the composition of the invention before step (a) by any known technique such as incipient wetness impregnation method.

An example of preparation of a catalytic composition according to this process corresponds to example 1 of EP 2969191: the composition of the invention is impregnated with a Pd nitrate solution using standard incipient wetness techniques. The Pd impregnated powder is placed into deionized water, and a Pt nitrate solution is added. After reducing the pH to 4 by addition of acid, the slurry is milled and the milled slurry is dried and calcined at 450° C. for 2 hours in air. Another example of a preparation is provided in example 1 of EP 3281697.

The catalytic composition may also comprise at least one element selected in the group consisting of the alkali metals and the alkaline earth metals. This element is usually in the form of an oxide. The element may be an alkali metal such as sodium or potassium. The element may also be an alkaline earth metal such as magnesium, barium or strontium. The element may be present in different forms in the catalytic composition:
according to an embodiment, it is present on the composition of the invention, e.g. for instance impregnated on it. An example of process of impregnation comprises the following steps: (a) bringing into contact the composition of the invention and a salt of an alkali metal or an alkaline earth metal, (b) drying the mixture and (c) optionally calcining in air the dried mixture. An example of preparation corresponds to example 1 of U.S. Pat. No. 9,611,774 B2: the composition of the invention is impregnated with a barium acetate solution, the mixture is dried at 110° C. and calcined at 720° C. for 2 hours;
according to another embodiment, it may be present in the inorganic material other than the composition of the invention. Typically it is present in the alumina-based material or in the ceria-based material.

As examples and without limitations, below are provided examples of catalytic compositions:
catalytic composition which may be used as a TWC or GPF catalyst comprising the composition of the invention; at least one mixed oxide of cerium, zirconium and at least one rare earth element; at least one alumina; at least one PGM e.g. a combination platinum+palladium+rhodium;
catalytic composition which may be used as a TWC or GPF catalyst comprising the composition of the invention; at least one mixed oxide of aluminium, cerium, zirconium and at least one rare earth element other than cerium; at least one alumina; at least one PGM e.g. a combination palladium+rhodium;
catalytic composition which may be used as a TWC or GPF catalyst comprising the composition of the invention; at least one mixed oxide of cerium, zirconium and at least one rare earth element; at least one PGM e.g. a combination palladium+rhodium;
catalytic composition which may be used as a DOC comprising the composition of the invention; at least one alumina; at least one zeolite; a least one PGM e.g. a combination platinum+palladium;
catalytic composition which may be used as a DOC comprising the composition of the invention; at least one zeolite; at least one PGM e.g. a combination platinum+palladium;
catalytic composition which may be used as a DPF comprising the composition of the invention; at least one alumina; at least one PGM e.g. platinum;
catalytic composition which may be used as a SCR comprising the composition of the invention; at least one zeolite containing copper oxide or iron oxide; boehmite;
catalytic composition which may be used as an LNT comprising the composition of the invention; at least one composite oxide of cerium and barium; at least one alumina; at least one PGM e.g. a combination platinum+palladium;
catalytic composition which may be used as an LNT comprising the composition of the invention; at least one composite oxide of cerium and barium; at least one PGM e.g. a combination platinum+palladium.

### Preparation Process

The invention also relates to a process for preparing the composition of the invention comprising the following steps:
(a) the following are introduced with stirring into a tank initially containing an aqueous solution comprising aluminium sulfate and having a pH of between 0.5 and 4.0 or even between 0.5 and 3.5
   (a1)—either an aqueous solution of sodium aluminate until a pH of the reaction mixture of between 8.0 and 10.0, or even between 8.5 and 9.5, is obtained;
   (a2)—or, simultaneously, (i) an aqueous solution of aluminum sulfate and (ii) an aqueous solution of sodium aluminate until a pH of the reaction mixture of between 6.5 and 10.0, or even between 7.0 and 8.0 or between 8.5 and 9.5, is obtained;
so that, at the end of step (a), the aluminum concentration of the reaction mixture expressed in oxide equivalent is between 0.5 wt % and 4.0 wt %;
(b) followed by simultaneous introduction of an aqueous solution of aluminum sulfate and an aqueous solution of sodium aluminate, the rates of introduction of which are such that the mean pH of the reaction mixture is maintained within the pH range targeted in step (a);
the temperature of the reaction mixture for steps (a) and (b) being between 50° C. and 70° C.;
(c) at the end of step (b), the pH of the reaction mixture is optionally adjusted to a value of between 7.5 and 10.5, or even between 8.0 and 9.5 or between 9.5 and 10.5;
(d) the reaction mixture is then filtered and the solid recovered is washed;
(e) at least one salt of cerium is brought into contact with the solid obtained at the end of step (d);
(f) the dispersion obtained on conclusion of step (f) is dried;
(g) the solid obtained from step (g) is then calcined in air;
characterized in that
   for composition C1 and C2, at least one salt of cerium is added in step (e) and may also be added before step (d), the proportion α of the salt of cerium added in step (e) being between 20% and 80%, preferably between 50% and 80%, α being calculated by the following formula: α=amount added in step (e)/total amount of cerium added×100; and
   for composition C2, at least one salt of lanthanum is added before step (d) or at step (f); and
   after step (d) and before step (e), there is no substantial reduction of the size of the solid by any mechanical or ultrasonication treatment of the solid.

### Preparation of the Acidic Aqueous Solution Initially Present in the Tank

The acidic aqueous solution initially contained in the tank comprises aluminium sulfate and has a pH of between 0.5 and 4.0 or even between 0.5 and 3.5.

As disclosed below for the description of step (e), at least one salt of cerium is added in step (e) by being brought into contact with the solid obtained at the end of step (d) and may also be present in the acidic aqueous solution initially present in the tank. In that case, the acidic aqueous solution initially contained in the tank comprises aluminium sulfate and at least one salt of cerium and has a pH of between 0.5 and 4.0 or even between 0.5 and 3.5.

Preferably, the aluminum concentration of the acidic solution initially contained in the tank expressed in oxide equivalent is between 0.01 wt % and 2.0 wt % or even between 0.01 wt % and 1.0 wt % or else even between 0.10 wt % and 1.0 wt %.

The acidic aqueous solution initially contained in the tank may be one disclosed in one of the examples. For instance, the acidic aqueous solution may be one made of aluminium sulfate and cerium (III) nitrate having a pH of 2.5 and an aluminium concentration expressed as oxide equivalent (Al₂O₃) of 0.13 wt %.

### Step (a)

In step (a), the following are introduced with stirring into a tank initially containing the acidic aqueous solution comprising aluminium sulfate and having a pH of between 0.5 and 4.0 or even between 0.5 and 3.5:
(a1)—either an aqueous solution of sodium aluminate until a pH of the reaction mixture of between 8.0 and 10.0, or even between 8.5 and 9.5, is obtained;
(a2)—or, simultaneously, (i) an aqueous solution of aluminum sulfate and (ii) an aqueous solution of sodium aluminate until a pH of the reaction mixture of between 6.5 and 10.0, or even between 7.0 and 8.0 or between 8.5 and 9.5, is obtained;
so that, at the end of step (a), the aluminium concentration of the reaction mixture expressed in oxide equivalent is between 0.5% and 4.0% by weight.

Step (a) is performed according to two embodiments (a1) or (a2). According to embodiment (a1), an aqueous solution of sodium aluminate is introduced with stirring. According to embodiment (a2), (i) an aqueous solution of aluminum sulfate and (ii) an aqueous solution of sodium aluminate are introduced simultaneously with stirring.

Preferably, the aqueous solution of sodium aluminate does not contain any precipitated alumina. The sodium aluminate preferably has an Na₂O/Al₂O₃ ratio of greater than or equal to 1.20, for example between 1.20 and 1.40.

The aqueous solution of sodium aluminate may have an aluminium concentration between 15.0 wt % and 35.0 wt %, more particularly between 15.0 wt % and 30.0 wt %, or even between 20.0 wt % and 30.0 wt %. The aqueous solution of aluminum sulfate may have an aluminium concentration of between 1.0 wt % and 15.0 wt %, more particularly between 5.0 wt % and 10.0 wt %.

On conclusion of step (a), the aluminium concentration of the reaction mixture expressed in oxide equivalent is between 0.5 wt % and 4.0 wt %. The aluminium concentration may more particularly be between 1.7 wt % and 2.0 wt %. The aluminium concentration may be as disclosed in one of the examples.

In this step (a), the time of introduction of the solution(s) is generally between 2 min and 30 min.

In step (a), the introduction of the aqueous solution of sodium aluminate has the effect of increasing the pH of the reaction mixture. In particular for embodiment (a1), the aqueous solution of sodium aluminate may be introduced directly into the reaction medium, for example via at least one introduction cannula. In particular for embodiment (a2), the two solutions may be introduced directly into the reaction medium, for example via at least two introduction cannulas.

For these two embodiments (a1) and (a2), the solution(s) are preferably introduced into a well-stirred zone of the reactor, for example into a zone close to the stirring rotor, so as to obtain an efficient mixing of the solution(s) introduced into the reaction mixture. For embodiment (a2), when the solutions are introduced via at least two introduction cannulas, the points of injection via which the two solutions are introduced into the reaction mixture are distributed so that the solutions become efficiently diluted in said mixture. Thus, for example, two cannulas may be arranged in the tank so that the points of injection of the solutions into the reaction mixture are diametrically opposed.

### Step (b)

In step (b), an aqueous solution of aluminum sulfate and an aqueous solution of sodium aluminate are introduced simultaneously, the rates of introduction of which solutions are regulated so as to maintain a mean pH of the reaction mixture within the pH range targeted in step (a). Thus, the target value of the mean pH is between:
8.0 and 10.0, or even between 8.5 and 9.5, for the case where embodiment (a1) was followed in step (a); or
6.5 and 10.0, or even between 7.0 and 8.0 or between 8.5 and 9.5, for the case where embodiment (a2) was followed in step (a).

The term “mean pH” means the arithmetic mean of the pH values of the reaction mixture which are recorded continuously during step (b).

Preferably, the aqueous solution of sodium aluminate is introduced at the same time as the aqueous solution of aluminum sulfate at a flow rate that is regulated so that the mean pH of the reaction mixture is equal to the target value. The flow rate of the aqueous solution of sodium aluminate which serves to regulate the pH may fluctuate in the course of step (b).

The time of introduction of the two solutions may be between 10 minutes and 2 hours, or even between 30 minutes and 90 minutes. The flow rate of introduction of the solution or the flow rates introduction of the two solutions may be constant.

The temperature of the reaction mixture for steps (a) and (b) is between 50° C. and 70° C. To do this, the solution initially contained in the tank in step (a) may have been preheated before the start of introduction of the solution(s). The solutions that are introduced into the tank in steps (a) and (b) may also be preheated beforehand.

### Step (c)

In step (c), the pH of the reaction mixture is optionally adjusted to a value of between 7.5 and 10.5, or even between 8.0 and 9.0 or between 9.0 and 10.0, by adding a basic or acidic aqueous solution.

The acidic aqueous solution that may be used for adjusting the pH may consist of an aqueous solution of a mineral acid, for instance sulfuric acid, hydrochloric acid or nitric acid. The acidic aqueous solution may also consist of an aqueous solution of an acidic aluminum salt such as aluminum nitrate, chloride or sulfate.

The basic aqueous solution that may be used for adjusting the pH may consist of an aqueous solution of a mineral base, for instance sodium hydroxide, potassium hydroxide or aqueous ammonia. The basic aqueous solution may also consist of an aqueous solution of a basic aluminum salt such as sodium aluminate. An aqueous solution of sodium aluminate is preferably used.

Preferably, the pH is adjusted by stopping:
(c1)—the introduction of the aqueous sulfate solution and the introduction of the aqueous solution of sodium aluminate is continued until the target pH is reached; or alternatively
(c2)—the introduction of the aqueous solution of sodium aluminate and the introduction of the aqueous solution of aluminum sulfate is continued until the target pH is reached.

According to one embodiment, the introduction of the aqueous solution of aluminum sulfate is stopped and the introduction of the aqueous solution of sodium aluminate is continued until a target pH of between 7.5 and 10.5, or even between 8.0 and 9.5 or between 9.5 and 10.5 is reached. The duration of step (c) may be variable. This duration may be between 5 min and 30 min.

### Step (d)

In step (d), the reaction mixture is filtered. The reaction mixture is generally in the form of a slurry. The solid recovered on the filter is washed with water. To do this, use may be made of hot water having a temperature of at least 50° C.

After step (d) and before step (e), there is no substantial reduction of the size of the solid by any mechanical or ultrasonication treatment of the solid. According to an embodiment, the expression “substantial reduction of the size” means that the difference in absolute value between the size D50 after step (d) and the size D50 before step (e) is less than 5.0 μm, more preferably less than 2.0 μm. It is known that mechanical (such as milling) or ultrasonication treatment have an impact on the size of solids with the effect of substantially reducing the size of the solid whereas other operations such as transferring, conveying or pumping the solid or a dispersion of the solid induces no such substantial reduction.

### Step (e)

In step (e), at least one salt of cerium is brought into contact with the solid obtained at the end of step (d). The salt of cerium is conveniently added to an aqueous dispersion of the solid.

The salt of cerium may be selected in the group consisting of cerium chloride, cerium acetate and cerium nitrate. The salt of cerium is preferably a salt of Ce (III). The salt of cerium may be cerium (III) nitrate or cerium (III) acetate.

The salt of cerium may also be added before step (d). For instance, the salt of cerium may be present in the acidic aqueous solution initially present in the tank (see before). It may also be added in step (a) or in step (b), e.g. in the solution containing aluminium sulfate.

The proportion α of the salt of cerium added in step (e) is between 20% and 80%, preferably between 30% and 80%, even more preferably between 50% and 80%, α being calculated by the following formula: α=amount added in step (e)/total amount of cerium added×100. α may be as disclosed in one of the examples.

For composition C2, at least one salt of lanthanum may also be added before step (d) or at step (e) to the solid obtained at the end of step (d) or to a dispersion of said solid.

The salts of cerium and of lanthanum, if any, are conveniently introduced in the form of aqueous solutions. An example of salt of lanthanum that may be used is lanthanum nitrate.

### Step (f)

In step (f), the dispersion from step (e) is dried.

Preferably, in step (f), the dispersion from step (e) is spray-dried. Spray-drying has the advantage of giving particles with a controlled particle size distribution. This drying method also offers good production efficiency. It consists in spraying the dispersion as a mist of droplets in a stream of hot gas (for example a stream of hot air) circulating in a chamber. The quality of the spraying controls the size distribution of the droplets and, consequently, the size distribution of the dried particles. The spraying may be performed using any sprayer known per se. Two main types of spraying devices exist: turbines and nozzles. Regarding the various spraying techniques that may be implemented in the present process, reference may be made notably to the standard manual by Masters entitled ‘Spray-Drying’ (second edition, 1976, published by George Godwin, London).

The operating parameters which a person skilled in the art can modify are notably the following: the flow rate and the temperature of the dispersion entering the sprayer; the flow rate, pressure, humidity and temperature of the hot gas. The inlet temperature of the gas is generally between 100° C. and 800° C. The outlet temperature of the gas is generally between 80° C. and 150° C.

The D50 of the powder recovered on conclusion of step (f) is generally between 2.0 μm and 80.0 μm. This size is linked to the size distribution of the droplets leaving the sprayer. The evaporation capacity of the atomizer is generally linked to the size of the chamber. Thus, on a laboratory scale (Büchi B 290), the D50 may be between 2.0 and 15.0 μm. On a larger scale, the D50 may be between 15.0 and 80.0 μm.

### Step (g)

In step (g), the solid obtained from step (f) is calcined in air. The calcination aims at converting the ingredients added in the previous steps into oxides and at developing the crystallinity of the composition. The calcination temperature is generally between 500° C. and 1000° C., more particularly between 800° C. and 1000° C. The calcination time is generally between 1 and 10 hours.

The balance between the calcination temperature and the calcination time should be adapted to convert the ingredients into oxides and to develop the crystallinity of the composition having in mind that too high a calcination temperature affects both the specific surface area and the mean crystallite size. The calcination conditions given in one of the examples may be used as they offer such a good balance.

It may be envisaged to perform the two steps (f) and (g) in the same equipment in which the dispersion obtained from step (e) undergoes a heat treatment for performing both drying and calcination.

Preferably, the composition that is recovered on conclusion of step (g) (i.e. at the end of the calcination) has a D50 generally between 2.0 μm and 80.0 μm. It generally has a D90 of less than or equal to 150.0 μm, more particularly less than or equal to 100.0 μm.

According to a second embodiment, at the end of step (g), the D50 may be between 15.0 and 80.0 μm, or even between 20.0 and 60.0 μm. The D90 may be between 40.0 μm and 150.0 μm, or even between 50.0 μm and 100.0 μm. This embodiment may rather be performed when step (e) is performed on a larger scale.

The process may also comprise a final step via which the solid obtained in the preceding step undergoes milling so as to adjust the particle size of the solid. Use may be made of a knife mill, an air jet mill, a hammer mill or a ball mill. Preferably, the milled product has a D50 generally between 2.0 μm and 15.0 μm. The D90 may be between 20.0 μm and 60.0 μm, or even between 25.0 μm and 50.0 μm.

The composition of the invention is in the form of a powder.

Should the disclosure of any patents, patent applications, and publications that are incorporated herein by reference conflict with the description of the present application to the extent that it may render a term unclear, the present description shall take precedence

### EXAMPLES

### Measurement of the Specific Surface Area:

For the continuation of the description, the term “specific surface area” means the BET specific surface area determined by nitrogen adsorption in accordance with the standard ASTM D 3663-03 established from the Brunauer-Emmett-Teller method described in the journal “The Journal of the American Chemical Society, 60, 309 (1938)”. The specific surface area is determined automatically using, for example, a Tristar II 3020 machine from Micromeritics in accordance with the instructions recommended by the manufacturer. The samples are pretreated at 250° C. for 90 min under vacuum (for example to reach a pressure of 50 mmHg). This treatment makes it possible to remove the physisorbed volatile species at the surface (for instance H₂O, etc.).

Measurement of the Porosity with Mercury (Hg Porosimetry)

The measurement is performed using a mercury porosimetry machine. In the present case, use was made of a Micromeritics Autopore IV 9520 machine equipped with a powder penetrometer, in accordance with the instructions recommended by the manufacturer. The following parameters were used: penetrometer used: 3.2 ml (Micromeritics reference: penetrometer type No. 8); capillary volume: 0.412 ml; max. pressure (“head pressure”): 4.68 psi; contact angle: 130°; surface tension of the mercury: 485 dynes/cm; density of the mercury: 13.5335 g/ml. At the start of the measurement, a vacuum of 50 mmHg is applied to the sample for 5 min. The equilibrium times are as follows: low pressure range (1.3-30 psi): 20 s-high pressure range (30-60 000 psi): 20 s. Prior to the measurement, the samples are treated at 200° C. for 120 min to remove the physisorbed volatile species at the surface (for instance H₂O, etc). From this measurement, the pore volumes may be deduced.

Measurement of the Porosity with N₂ Porosimetry

Nitrogen porosity use was made of a Tristar II 3020 device from Micromeritics following the guidelines of the constructor. The Barett, Joyner and Halenda (BJH) method with the Harkins-Jura law was used. The analysis of the results is carried out on the desorption curve. The physisorbed volatile species are removed before any measurement.

X-ray diffraction: use was made of an x-ray diffractometer X'Pert Pro with a copper source (CuKα1, λ=1.5406 Angstrom).

### Measurement of the Particle Size (D10, D50, D90)

To perform the particle size measurements, use is made of a Malvern Mastersizer 2000 or 3000 laser diffraction particle size analyzer (further details regarding this machine are given here: https://www.malvernpanalytical.com/fr/products/product-range/mastersizer-range/mastersizer-3000). The laser diffraction technique used consists in measuring the intensity of the light scattered during the passage of a laser beam through a sample of dispersed particles. The laser beam passes through the sample and the intensity of the scattered light is measured as a function of the angle. The diffracted intensities are then analyzed to calculate the particle size using the Mie scattering theory. The measurement makes it possible to obtain a volume-based size distribution, from which the parameters D10, D50 and D90 are deduced.

Further details for the preparation of the composition of the invention will be found in the following illustrative examples. For examples 1-3, the compositions were prepared according to the process of the invention with a reactor initially loaded with an acidic aqueous solution of aluminium sulfate and cerium (III) nitrate. The rest of the cerium (III) nitrate was introduced in step (e). For comparative example 4, all the cerium (III) nitrate was introduced in the acidic solution initially present in the tank. Embodiment (a1) of the process was followed.

### Example 1: Composition with Al₂O₃ (92.0%) and CeO₂ (8.0 wt %) with α=50%

112.1 kg of deionized water are introduced into a stirred reactor and heated to 65° C. This temperature is maintained throughout steps (a) to (c). An acidic aqueous solution mixture consisting of 56.23 kg of aluminum sulfate solution with a concentration of 8.3 wt % of alumina (Al₂O₃), 2.44 kg of cerium (III) nitrate solution with a concentration of 29.0 wt % of ceria (CeO₂), and 860 grams of deionized water is made up.

Preparation of the acidic aqueous solution initially contained in the tank: 1.9 kg of the acid mixture is introduced at a flow rate of 392.9 g of solution/min via an introduction cannula close to the stirring rotor. At the end of the introduction, the pH in the reactor is close to 2.5 and the aluminium concentration expressed as oxide is 0.13% by weight (Al₂O₃). The introduction of the acid mixture is then stopped.

In step (a): the acid mixture is introduced at a flow rate of 1.113 kg of solution/min simultaneously with a sodium aluminate solution (having a concentration of 24.9 wt % of alumina (Al₂O₃) and a Na₂O/Al₂O₃ molar ratio of 1.27) at a flow rate of 1.255 kg of solution/min via a second introduction cannula close to the stirring rotor, until a pH of 9.0 is reached. The aluminium concentration of the reaction mixture expressed as oxide equivalent is 1.93%.

In step (b), the introduction rate of the acidic solution is maintained at 1.113 kg of solution/min while the sodium aluminate solution is regulated so as to maintain the pH at a value of 9.0. This step lasts for 46 minutes.

In step (c), the introduction of the acid mixture is stopped and the addition of the sodium aluminate solution is continued at a flow rate of 327 g of solution/min until a pH of 10.3 is reached. The addition of the sodium aluminate solution is stopped.

In step (d), the reaction slurry is poured onto a vacuum filter. At the end of the filtration step, the cake is washed with deionized water at 65° C.

In step (e), the cake is redispersed in deionized water to obtain a suspension having a concentration close to 9 wt % of oxide (Al₂O₃). A cerium nitrate solution is prepared at a concentration of 29.0% by weight of oxide (CeO₂). This solution is added with stirring to the suspension obtained from step (e) so as to obtain a CeO₂/(CeO₂+Al₂O₃) mass ratio of 8.0 wt %.

In step (f), the suspension obtained from step (e) is spray-dried to obtain a dried powder. In step (g), the spray-dried powder is calcined in air at 850° C. for 2 hours (temperature increase rate of 3° C./min).

### Example 2: Composition with Al₂O₃ (88.0%) and CeO₂ (12.0 wt %) with α=33%

108 kg of deionized water are introduced into a stirred reactor and heated to 65° C. This temperature is maintained throughout steps (a) to (c). An acid mixture consisting of 53.88 kg of aluminum sulfate solution with a concentration of 8.3 wt % of alumina (Al₂O₃), 4.88 kg of cerium (III) nitrate solution with a concentration of 29.0 wt % of ceria (CeO₂), and 6.46 kg of deionized water is made up.

Preparation of the acidic aqueous solution initially contained in the tank: 1.96 kg of the acid mixture is introduced at a flow rate of 392.9 g of solution/min via an introduction cannula close to the stirring rotor. At the end of the introduction, the pH in the reactor is close to 2.5 and the aluminium concentration expressed as oxide is 0.12% by weight (Al₂O₃). The introduction of the acid mixture is then stopped.

In step (a), the acid mixture is introduced at a flow rate of 1.223 kg of solution/min simultaneously with a sodium aluminate solution (with a concentration of 24.9 wt % of alumina (Al₂O₃) and a Na₂O/Al₂O₃ molar ratio of 1.27) at a flow rate of 1.203 kg of solution/min via a second introduction cannula close to the stirring rotor, until a pH of 9.0 is reached. The aluminium concentration of the reaction mixture expressed as oxide equivalent is 1.88%.

In step (b), The introduction rate of the acidic solution is maintained at 1.223 kg of solution/min while the sodium aluminate solution is regulated so as to maintain the pH at a value of 9.0. This step lasts for 46 minutes.

In step (c), the introduction of the acid mixture is stopped and the addition of the sodium aluminate solution is continued at a flow rate of 313 g of solution/min until a pH of 10.3 is reached. The addition of the sodium aluminate solution is stopped.

In step (d), the reaction slurry is poured onto a vacuum filter. At the end of the filtration step, the cake is washed with deionized water at 65° C.

In step (e), the cake is redispersed in deionized water to obtain a suspension having a concentration close to 9 wt % of oxide (Al₂O₃). A cerium (III) nitrate solution is prepared at a concentration of 29.0% by weight of oxide (CeO₂). This solution is added with stirring to the suspension obtained from step (e) so as to obtain the targeted composition with CeO₂/(CeO₂+Al₂O₃) mass ratio of 12 wt %.

In step (f), the suspension obtained from step (e) is spray-dried to obtain a dried powder.

In step (g), the spray-dried powder is calcined in air at 850° C. for 2 hours (temperature increase rate of 3° C./min).

### Example 3: Composition with Al₂O₃ (80.0%) and CeO₂ (20.0 wt %) with α=60%

108 kg of deionized water are introduced into a stirred reactor and heated to 65° C. This temperature is maintained throughout steps (a) to (c). An acid mixture consisting of 53.88 kg of aluminum sulfate solution with a concentration of 8.3 wt % of alumina (Al₂O₃), 4.88 kg of cerium nitrate solution with a concentration of 29.0 wt % of ceria (CeO₂), and 6.46 kg of deionized water is made up.

Preparation of the acidic aqueous solution initially contained in the tank: 1.96 kg of the acid mixture is introduced at a flow rate of 392.9 g of solution/min via an introduction cannula close to the stirring rotor. At the end of the introduction, the pH in the reactor is close to 2.5 and the aluminium concentration expressed as oxide is 0.12% by weight (Al₂O₃). The introduction of the acid mixture is then stopped.

In step (a), the acid mixture is introduced at a flow rate of 1.223 kg of solution/min simultaneously with a sodium aluminate solution (with a concentration of 24.9 wt % of alumina (Al₂O₃) and a Na₂O/Al₂O₃ molar ratio of 1.27) at a flow rate of 1.203 kg of solution/min via a second introduction cannula close to the stirring rotor, until a pH of 9.0 is reached. The aluminium concentration of the reaction mixture expressed as oxide equivalent is 1.88%.

In step (b), The introduction rate of the acidic solution is maintained at 1.223 kg of solution/min while the sodium aluminate solution is regulated so as to maintain the pH at a value of 9.0. This step lasts for 46 minutes.

In step (c), the introduction of the acid mixture is stopped and the addition of the sodium aluminate solution is continued at a flow rate of 313 g of solution/min until a pH of 10.3 is reached. The addition of the sodium aluminate solution is stopped.

In step (d), the reaction slurry is poured onto a vacuum filter. At the end of the filtration step, the cake is washed with deionized water at 65° C.

In step (e), the cake is redispersed in deionized water to obtain a suspension having a concentration close to 9 wt % of oxide (Al₂O₃). A cerium nitrate solution is prepared at a concentration of 29% by weight of oxide (CeO₂). This solution is added with stirring to the suspension obtained from step (e) so as obtain to the targeted composition with CeO₂/(CeO₂+Al₂O₃) mass ratio of 20 wt %.

In step (f), the suspension obtained from step (e) is spray-dried to obtain a dried powder.

In step (g), the spray-dried powder is calcined in air at 850° C. for 2 hours (temperature increase rate of 3° C./min).

### Example 4 (Comparative): Composition with Al₂O₃ (80.0%) and CeO₂ (20.0 wt %) with α=0% (No Added Cerium in Step (e))

97.6 kg of deionized water are introduced into a stirred reactor and heated to 65° C. This temperature is maintained throughout steps (a) to (c). An acid mixture consisting of 46.86 kg of aluminum sulfate solution with a concentration of 8.3 wt % of alumina (Al₂O₃), 12.21 kg of cerium nitrate solution with a concentration of 29.0 wt % of ceria (CeO₂), and 23.28 kg of deionized water is made up.

Preparation of the acidic aqueous solution initially contained in the tank: 1.96 kg of the acid mixture is introduced at a flow rate of 392.9 g of solution/min via an introduction cannula close to the stirring rotor. At the end of the introduction, the pH in the reactor is close to 2.5 and the alumina concentration is 0.09% by weight of alumina (Al₂O₃). The introduction of the acid mixture is then stopped.

In step (a), the acid mixture is introduced at a flow rate of 1.554 kg of solution/min simultaneously with a sodium aluminate solution (with a concentration of 24.9 wt % of alumina (Al₂O₃) and a Na₂O/Al₂O₃ molar ratio of 1.27) at a flow rate of 1.046 kg of solution/min via a second introduction cannula close to the stirring rotor, until a pH of 9.0 is reached. The aluminium concentration of the reaction mixture expressed as oxide equivalent is 1.75%.

In step (b), the introduction rate of the acidic solution is maintained at 1.554 kg of solution/min while the sodium aluminate solution is regulated so as to maintain the pH at a value of 9.0. This step lasts for 46 minutes.

In step (c), the introduction of the acid mixture is stopped and the addition of the sodium aluminate solution is continued at a flow rate of 272 g of solution/min until a pH of 10.3 is reached. The addition of the sodium aluminate solution is stopped.

In step (d), the reaction slurry is poured onto a vacuum filter. At the end of the filtration step, the cake is washed with deionized water at 65° C.

In step (e), the cake is redispersed in deionized water to obtain a suspension having a concentration close to 9 wt % of oxide (Al₂O₃). There is no added cerium in this step.

In step (f), the suspension obtained from step (e) is spray-dried to obtain a dried powder.

In step (g), the spray-dried powder is calcined in air at 850° C. for 2 hours (temperature increase rate of 3° C./min).

TABLE I

| | | | | D_{900° C.-2 h} | ΔD | bulk |
|---|---|---|---|---|---|---|
| | | BET | pore volumes | D_{1100° C.-5 h} | by XRD | density |
| Ex. | | (m²/g) | (mL/g) | by XRD (nm) | (nm) | (g/cm³) |
| 1 | 92.0% Al₂O₃ - | fresh: 162 | Hg porosimetry | 9.8 | 22.3 | 0.31 |
| | 8.0% CeO₂ | 1100° C./5 | PV₅₋₁₀₀ = 0.80 | 32.1 | | |
| | α = 50% | h: 84 | PV₅₋₁₀₀₀ = 0.93 | | | |
| | | | PV₁₀₀₋₁₀₀₀ = 0.13 | | | |
| | | | TPV = 2.01 | | | |
| | | | N₂ porosimetry | | | |
| | | | TPV* = 0.69 | | | |
| 2 | 88.0% Al₂O₃ - | fresh: 160 | N₂ porosimetry | 9.8 | 23.8 | 0.35 |
| | 12.0% CeO₂ | 1100° C./5 | TPV* = 0.77 | 33.6 | | |
| | α = 33% | h: 79 | | | | |
| 3 | 80.0% Al₂O₃ - | fresh: 150 | Hg porosimetry | 11.7 | 25.1 | 0.25 |
| | 20.0% CeO₂ | 1100° C./5 | PV₅₋₁₀₀ = 0.70 | 36.8 | | |
| | α = 60% | h: 70 | PV₅₋₁₀₀₀ = 0.97 | | | |
| | | | PV₁₀₀₋₁₀₀₀ = 0.27 | | | |
| | | | TPV = 2.09 | | | |
| | | | N2 porosimetry) | | | |
| | | | TPV* = 0.67 | | | |
| Comp | 80.0% Al₂O₃ - | fresh: 160 | Hq porosimetry | 20.2 | 42.8 | 0.21 |
| 4 | 20.0% CeO₂ | 1100° C./5 | PV₅₋₁₀₀ = 0.97 | 63.0 | | |
| | α = 0% | h: 77 | PV₅₋₁₀₀₀ = 1.36 | | | |
| | | | PV₁₀₀₋₁₀₀₀ = 0.39 | | | |
| | | | TPV = 2.94 | | | |
| | | | N2 porosimetry | | | |
| | | | TPV* = 0.86 | | | |

TPV*: total pore volume measured by N2 porosimetry after calcination at 900° C. for 2 hours

As is visible, the process of the invention makes it possible to obtain a composition with a low crystallite size at 900° C. and 1100° C.

1. A composition which is:
a composition C1 which is based on Al and Ce in the form of oxides; or
a composition C2 which is based on Al, Ce and La in the form of oxides.
with the following proportions:
the proportion of CeO₂ is between 5.0 wt % and 35.0 wt %;
the proportion of La₂O₃ (for composition C2 only) is between 0.1 wt % and 6.0 wt %;
the remainder being Al₂O₃;
and exhibiting the following porosity profile:
a pore volume in the range of pores with a size of between 5 nm and 100 nm (PV_{5-100 nm}) which is:
for a proportion of CeO₂ between 5.0 wt % and 15.0 wt % lower than 0.90 mL/g;
for a proportion of CeO₂ between 15.0 wt % (this value being excluded) and 22.0 wt % lower than 0.85 mL/g;
for a proportion of CeO₂ between 22.0 wt % (this value being excluded) and 35.0 wt % lower than 0.70 mL/g;
a pore volume in the range of pores with a size of between 5 nm and 1000 nm (PV_{5-1000 nm}) which is lower than 1.30 mL/g;
a pore volume in the range of pores with a size of between 100 nm and 1000 nm (PV_{100-1000 nm}) which is strictly higher than 0.10 mL/g;
these pore volumes being determined by means of a mercury porosimetry technique;
and exhibiting the following properties:
a mean size of crystallites after calcination in air at 1100° C. for 5 hours (D_{1100° C.-5h}) which is lower than 45.0 nm;
a mean size of crystallites after calcination in air at 900° C. for 2 hours (D_{900° C.-2h}) which is lower than 25.0 nm; and
an increase ΔD of the mean size of the crystallites lower than 30.0 nm, ΔD being calculated with the following formula: ΔD=D_{1100° C.-5h}−D_{900° C.-2h};
the mean size of crystallites being obtained by XRD from the diffraction peak of the cubic phase corresponding to cerium oxide, generally present at 2θ between 28.0° and 30.0°.

2. The composition according to claim 1 consisting of oxides of Ce and Al (composition C1) or consisting of oxides of Ce, Al and La (composition C2).

3. The composition according to claim 1, wherein the proportion of CeO₂ is between 5.0 wt % and 30.0 wt %.

4. (canceled)

5. (canceled)

6. The composition according to claim 1, wherein the composition is C1 and proportions of CeO₂ and Al₂O₃ are between:
6.0 wt % and 10.0 wt % for CeO₂ and 90.0 wt % and 94.0 wt % for Al₂O₃;
10.0 wt % and 14.0 wt % for CeO₂ and 86.0 wt % and 90.0 wt % for Al₂O₃; or
18.0 wt % and 22.0 wt % for CeO₂ and 78.0 wt % and 82.0 wt % for Al₂O₃.

7. The composition according to claim 1, wherein the proportion of Al₂O₃ is:
between 65.0 wt % and 95.0 wt % for composition C1; or
between 59.0 wt % and 94.9 wt % for composition C2.

8. The composition according to a claim 1 comprising a crystalline phase based on alumina.

9. The composition according to claim 1 comprising a crystalline phase based on cerium oxide, wherein the crystalline phase based on cerium oxide corresponds to pure CeO₂ or to CeO₂ containing lanthanum for composition C2.

10. (canceled)

11. The composition according to claim 1, wherein D_{1100° C.-5h} is at least 8.0 μm and lower than 40.0 nm,
wherein D_{900° C.-2h} is at least 5.0 nm and lower than 20.0 nm, and
wherein ΔD is lower than 25 nm.

12-15. (canceled)

16. The composition according to a claim 1, wherein PV_{5-100 nm} is:
for a proportion of CeO₂ between 5.0 wt % and 15.0 wt % lower than 0.85 mL/g;
for a proportion of CeO₂ between 15.0 wt % (this value being excluded) and 22.0 wt % lower than 0.80 mL/g; or
for a proportion of CeO₂ between 22.0 wt % (this value being excluded) and 35.0 wt % lower than 0.65 mL/g; and
wherein PV_{5-1000 nm} is lower than 1.20 ml/g.

17-24. (canceled)

25. The composition according to claim 1,
wherein PV_{5-100 nm} is:
for a proportion of CeO₂ between 5.0 wt % and 15.0 wt % between 0.40 and 0.90 mL/g;
for a proportion of CeO₂ between 15.0 wt % (this value being excluded) and 22.0 wt % between 0.35 and 0.85 mL/g;
for a proportion of CeO₂ between 22.0 wt % (this value being excluded) and 35.0 wt % between 0.30 and 0.70 mL/g; and
wherein PV_{5-1000 nm} is between 0.70 and 1.30 mL/g.

26. The composition according to claim 1 exhibiting a BET specific surface area between 80 and 300 m²/g;
a BET specific surface area after calcination in air at 1100° C. for 5 hours which is higher than 40 m²/g; or
a BET specific surface area after calcination in air at 1200° C. for 5 hours which is between 25 m²/g and 60 m²/g.

27-30. (canceled)

31. The composition according to claim 1 exhibiting a total pore volume (TPV) which is no more than 2.50 mL/g, the total pore volume being determined by means of the mercury porosimetry technique, or
exhibiting a TPV measured by N₂ porosimetry after calcination in air at 900° C. for 2 hours which is strictly lower than 0.97×(Al₂O₃)+0.0647 mL/g wherein (Al₂O₃) corresponds to the proportion of Al₂O₃ in wt % in the composition.

32. (canceled)

33. The composition according to claim 1 exhibiting a bulk density between 0.20 g/cm³ and 0.50 g/cm³.

34. (canceled)

35. The composition according to claim 1, having a sodium content of less than or equal to 0.50 wt %, this sodium content being expressed as weight of Na₂O relative to the total weight of the composition; and having a sulfate content of less than or equal to 1.00 wt %, this sulfate content being expressed as weight of SO₄ relative to the total weight of the composition.

36-38. (canceled)

39. A catalytic composition comprising:
(i) the composition according to claim 1; and
(ii) optionally at least one inorganic material other than the composition; and/or
(iii) optionally at least one platinum group metal (PGM).

40. (canceled)

41. (canceled)

42. The catalytic composition according to claim 39, wherein the inorganic material (ii) is selected in the group consisting of zeolites; alumina-based materials; ceria-based materials; zirconia-based materials; mixed oxides comprising oxides of cerium and zirconium; mixed oxides comprising oxides of aluminium, cerium and zirconium; and combinations thereof.

43. The catalytic composition according to claim 39, wherein the PGM is selected in the group consisting of Pt, Pd, Rh and combinations thereof.

44. The catalytic composition according to claim 39, further comprising at least one element selected in the group consisting of alkali metals and alkaline earth metals.

45. (canceled)

46. A method of preparing a catalytic converter from the catalytic composition of claim 39.

47. A process for preparing a composition according to claim 1, the method comprising the following steps:
(a) the following are introduced with stirring into a tank initially containing an aqueous solution comprising aluminium sulfate and having a pH of between 0.5 and 4.0;
(a1)—either an aqueous solution of sodium aluminate until a pH of the reaction mixture of between 8.0 and 10.0 is obtained;
(a2)—or, simultaneously, (i) an aqueous solution of aluminum sulfate and (ii) an aqueous solution of sodium aluminate until a pH of the reaction mixture of between 6.5 and 10.0 is obtained;
so that, at the end of step (a), the aluminum concentration of the reaction mixture expressed in oxide equivalent is between 0.5 wt % and 4.0 wt %;
(b) followed by simultaneous introduction of an aqueous solution of aluminum sulfate and an aqueous solution of sodium aluminate, the rates of introduction of which are such that the mean pH of the reaction mixture is maintained within the pH range targeted in step (a);
the temperature of the reaction mixture for steps (a) and (b) being between 50° C. and 70° C.;
(c) at the end of step (b), the pH of the reaction mixture is optionally adjusted to a value of between 7.5 and 10.5;
(d) the reaction mixture is then filtered and the solid recovered is washed;
(e) at least one salt of cerium is brought into contact with the solid obtained at the end of step (d) to form a suspension;
(f) the suspension obtained on conclusion of step (f) is dried;
(g) the solid obtained from step (f) is then calcined in air
wherein
for composition C1 and C2, at least one salt of cerium is added in step (e) and may also be added before step (d), the proportion α of the salt of cerium added in step (e) being between 20% and 80%, preferably between 50% and 80%, α being calculated by the following formula: α=amount added in step (e)/total amount of cerium added×100; and
for composition C2, at least one salt of lanthanum is added before step (d) or at step (f); and
after step (d) and before step (e), there is no substantial reduction of the size of the solid by any mechanical or ultrasonication treatment of the solid.
